(19) United States
(12) Patent Application Publication
(10) Pub. No.: US 2018/0088512 A1
(43) Pub. Date: Mar. 29, 2018

(54) IMAGE FORMING APPARATUS AND METHOD OF SAME

(71) Applicant: CANON KABUSHIKI KAISHA, Tokyo (JP)

(72) Inventor: Koichi Watanabe, Abiko-shi (JP)

(21) Appl. No.: 15/703,856

(22) Filed: Sep. 13, 2017

(30) Foreign Application Priority Data
Sep. 29, 2016 (JP) 2016-191196

(51) Int. Cl. G03G 15/00; G03G 21/16

(52) U.S. Cl. CPC G03G 15/6552; G03G 15/0189; G03G 21/1647; G03G 21/1633

(57) ABSTRACT

An image forming apparatus includes a conveying unit to convey a recording medium, a sheet discharge unit provided inside the apparatus body to receive the recording medium, a cover that opens and closes to allow access to the conveying unit, an operation unit to operate the image forming apparatus, a support unit to slidably support the operation unit, and an urging member. The urging member urges the operation unit towards a movement destination when the operation unit is slid. The operation unit slides to a first position protruding outside of the cover and a second position positioned inside the first position to cover at least a portion of the sheet discharge unit. The urging member urges the operation unit towards the first position when the operation unit is near the first position, and biases the operation unit towards the second position when the operation unit is near the second position.

### BACKGROUND OF THE INVENTION

### Field of the Invention

The present disclosure relates to copiers, printers, facsimiles, and image forming apparatuses provided with the above functions in a multiple manner, and to a method of the same.

### Description of the Related Art

In recent years, in the mainstream of the image forming apparatuses, the image forming apparatus is designed so as to be vertically long with a compact horizontal size so that the image forming apparatus does not get in the way is small office environments, and the discharge tray is not provided on the lateral side of the main body of the image forming apparatus; the sheet is discharged inside the body. In such an image forming apparatus, a small liquid crystal display is used in the operation unit so as to improve the visibility of the recoding medium discharged inside the body.

Meanwhile, high-end image forming apparatuses are becoming more complex and more multifunctional, and the operation unit is becoming larger in accordance with the above, such that wide-sized displays having a wide liquid crystal display area are increasingly used. In high-speed apparatuses developed for print-on-demand (POD) markets, there are cases in which the operation unit is provided on the rear side of the apparatus due to attaching importance to ease of operation and functionality. Meanwhile, in a typical piece of office equipment, even if the operation unit has a wide liquid crystal display area, the operation unit is provided in a fixed manner on the main body of the apparatus so as to protrude from the front side of the apparatus. However, in cases in which an operation unit on which a wide liquid crystal display is mounted is attached to an image forming apparatus that outputs, at the largest, an A4-sized sheet, there may be cases in which the operation unit is disposed such that a portion of the in-body sheet discharge unit is covered and hidden. In such cases, the visibility of the discharged sheet is hindered, the discharged sheet is not noticed, or some of the sheets are left behind. Accordingly, one may conceive of configuring a slidable operation unit that allows the position of the operation unit to be changed so that the visibility of the in-body sheet discharge unit is improved. In Japanese Patent Laid-Open. No. 2013-70279, the operation unit is configured in two layers so that one layer can slide with respect to the other layer.

As described above, in cases in which the operation unit is configured to be slidable with respect to the body in order to improve the visibility of the sheet discharge unit, there may be cases in which the operation unit protrudes out from the outer frame of the main body of the apparatus. In a case in which the operation unit is allowed to slide to a position where the operation unit protrudes from the outer frame of the main body of the image forming apparatus, the operation unit may be in the way when performing a jam clearance operation. In such a case, the operator performing the jam clearance operation may temporality need to slide the operation unit to a position that is not in the way; however, in order to reduce the load on the operator during the jam clearance operation as much as possible, the load in sliding the operation unit needs to be reduced.

### SUMMARY OF THE INVENTION

According to an aspect of the present invention, an image forming apparatus includes a conveying unit configured to convey a recording medium, a sheet discharge unit provided inside a body of the image forming apparatus and configured to receive the recording medium, a cover provided on the image forming apparatus and configured to be opened and closed to allow access to the conveying unit, an operation unit configured to be used to operate the image forming apparatus, a support unit configured to support the operation unit in a slidable manner, and an urging member configured to urge the operation unit towards a movement destination when the operation unit is slid, wherein the operation unit is configured to slide to a first position protruding outside of the cover, and slide to a second position positioned inside the first position to cover at least a portion of the sheet discharge unit, wherein the urging member is configured to urge the operation unit towards the first position when the operation unit is positioned nearer to the first position with respect to a predetermined position between the first position and the second position, and is configured to bias the operation unit towards the second position when the operation unit is positioned nearer to the second position with respect to the predetermined position, and wherein L1<L2 is satisfied, where L1 is a stroke amount from the first position to the predetermined position, and L2 is a stroke amount from the second position to the predetermined position.

Further features of the present invention will become apparent from the following description of embodiments with reference to the attached drawings.

### BRIEF DESCRIPTION OF THE DRAWINGS

FIG. 1 is a schematic cross-sectional view of an image forming apparatus.

FIG. 2 is a right side view of the image forming apparatus.

FIG. 3 is a front view of the image forming apparatus in which an operation unit is positioned at a first position.

FIG. 4 is a front view of the image forming apparatus in which the operation unit is positioned at a second position.

FIG. 5 is a diagram of the operation unit attached to the image forming apparatus viewed from the rear side.

FIG. 6 is a rear view of the operation unit.

FIG. 7 is a schematic drawing of the operation unit positioned at the first position.

FIG. 8 is a schematic drawing illustrating a position of the operation unit when urging force acting on the operation unit is at its peak.

FIG. 9 is a schematic drawing of the operation unit positioned at a second position.

### DESCRIPTION OF THE EMBODIMENTS

### Image Forming Apparatus

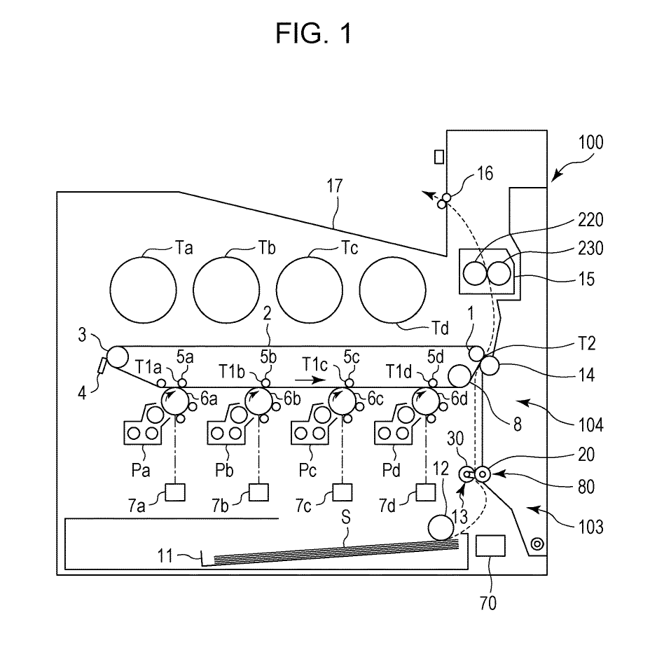

A configuration of a printer device (main body of image forming apparatus) 100 will be described with reference to FIG. 1.

FIG. 1 is a cross-sectional view illustrating a schematic configuration of the printer device 100. As illustrated in FIG. 1, the printer device 100 includes a sheet cassette 11 that stores sheets S serving as recording mediums, and a sheet conveying unit 103 that feeds and conveys the sheet S from the sheet cassette 11. The printer device 100 includes an image forming unit 104 that forms an image on the sheet S conveyed by the sheet conveying unit 103, a discharge roller 16 that discharges the sheet S on which an image has been formed, and a sheet loading unit 17 on which the discharged sheet S is stacked. The sheet conveying unit 103 includes a feed roller 12 that feeds the sheets S stored in the sheet cassette 11 sheet by sheet with a frictional separation method. The sheet conveying unit 103 includes a pair of conveying rollers 13 including a first roller 30 and a second roller 20 that further conveys the fed sheet S. The sheet conveying unit 103 includes a skew correction mechanism 80 that corrects the skew of the sheet S conveyed to the pair of conveying rollers 13. The printer device 100 includes a control unit 70 serving as a control member that controls the overall sheet conveying unit 103 including the feed roller 12 and the pair of conveying rollers 13. Note that the control unit 70 not only controls the sheet conveying unit 103 but also controls the overall printer device 100 including the image forming unit 104.

The image forming unit 104 includes four process cartridges Pa to Pd that form images of four colors, namely, yellow (Y), magenta (M), cyan (C), and black (K), and exposing devices 7a to 7d that each emit a laser beam according to image data. The process cartridges Pa to Pd include photosensitive drums 6a to 6d on which electrostatic latent images are formed. Since the four process cartridges Pa to Pd are configured in the same manner other than having differences in the color of the formed image, description of the process cartridges Pb to Pd are omitted. The image forming unit 104 includes an endless intermediate transfer belt 2 on which toner images of the photosensitive drums 6a to 6d are primarily transferred, and primary transfer rollers 5a to 5d that primarily transfer the toner images on the photosensitive drums 6a to 6d to the intermediate transfer belt 2. The primary transfer rollers 5a to 5d form primary transfer portions T1a to T1d by nipping the intermediate transfer belt 2 together with the photosensitive drums 6a to 6d. In the primary transfer portions T1a to T1d, the toner images of various colors formed on the photosensitive drums 6a to 6d are transferred onto the intermediate transfer belt 2.

The image forming unit 104 includes a secondary inner transfer roller 1, a tension roller and a secondary transfer upstream roller 6 the support the intermediate transfer belt 2 in a tensioned state, and a transfer cleaning unit 4 that cleans the intermediate transfer belt 2. The image forming unit 104 includes toner cartridges Ta to Td that supply toner to the process cartridges Pa to Pd. The image forming unit 104 includes a secondary transfer roller 14 that secondarily transfers the primarily transferred toner images onto the sheet S, and a fixing unit 15 that fixes the secondarily transferred toner images to the sheet S by heat and pressure.

A print job (an image forming operation) performed with the control unit 70 of the printer device 100 configured in the above manner will be described next. When a print job is started according to a setting of an operation unit (not shown) or the like, the exposing devices 7a to 7d emit laser beams towards the photosensitive drums 6a to 6d on the basis of image data input through an external PC or the like. In so doing, electrostatic latent images are formed on the photosensitive drums 6a to 6d by having the laser beams emitted to the photosensitive drums 6a to 6d that have been electrostatically pre-charged to a potential with a negative polarity. Inversed development is performed on the electrostatic latent images and negative toner is adhered to the photosensitive drums 6a to 6d such that toner images of yellow (Y), magenta (M), cyan (C), and black (K) are formed on photosensitive drums 6a to 6d.

The toner images of various colors formed on the photosensitive drums 6a to 6d are transferred to the intermediate transfer belt 2 at the primary transfer portions T1a to T1d. Positive primary transfer biases applied to the primary transfer rollers 5a to 5d and pressure force generated between the primary transfer rollers 5a to 5d and the intermediate transfer belt 2 act on the toner images of various colors at the primary transfer portions T1a to T1d. With the above, the toner images of various colors formed on the photosensitive drums 6a to 6d are transferred from the photosensitive drums 6a to 6d to the intermediate transfer belt 2 at the primary transfer portions T1a to T1d so as to be superimposed in a sequential manner.

The toner images of four colors transferred onto the intermediate transfer belt 2 in a superimposed manner are conveyed to the secondary transfer roller 14 with the rotational drive of the intermediate transfer belt 2. Concurrently with the toner image forming operation, the sheets S stored in the sheet cassette 11 are separated and fed sheet by sheet with the feed roller 12. The separated and fed sheet S is conveyed to the pair of conveying rollers 13 at a predetermined timing. While the skew of the sheet S is corrected with the skew correction mechanism 80, the pair of conveying rollers 13 convey the sheet S to a secondary transfer portion 12 where the secondary transfer roller 14 and the intermediate transfer belt 2 nips the sheet S. A positive secondary transfer bias applied to the secondary transfer roller 14 and pressure force generated between the secondary transfer roller 14 and the intermediate transfer belt 2 act on the sheet S conveyed to the secondary transfer portion T2. With the above, the toner image of four colors on the intermediate transfer belt 2 is secondarily transferred to the sheet S.

The sheet S on which the toner image has been transferred is conveyed to the fixing unit 15 equipped with a heating roller 220 and a conveying roller 230, and is heated and compressed so that the toner image is fixed. Subsequently, the sheet S on which the toner image has been fixed is discharged to and stacked on the sheet loading unit 17 with the discharge roller 16.

### Configurations of Operation Unit and Image Forming Apparatus

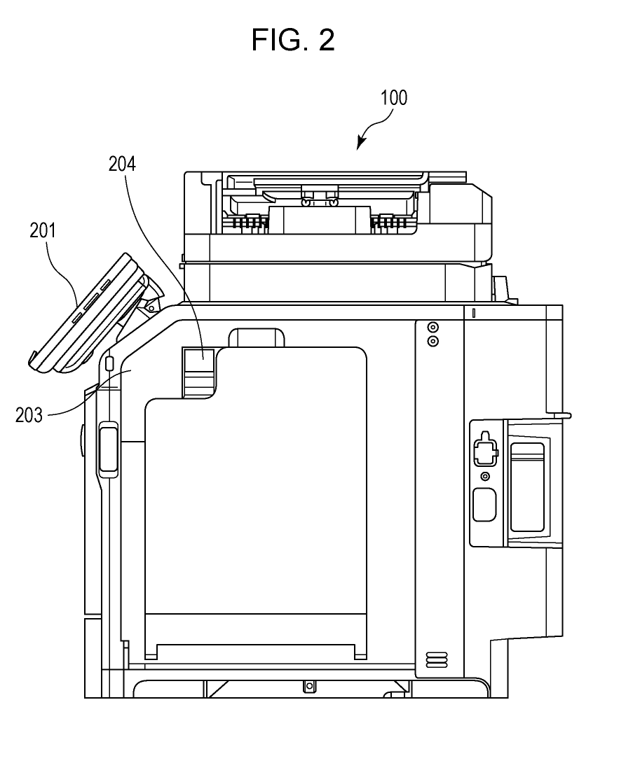

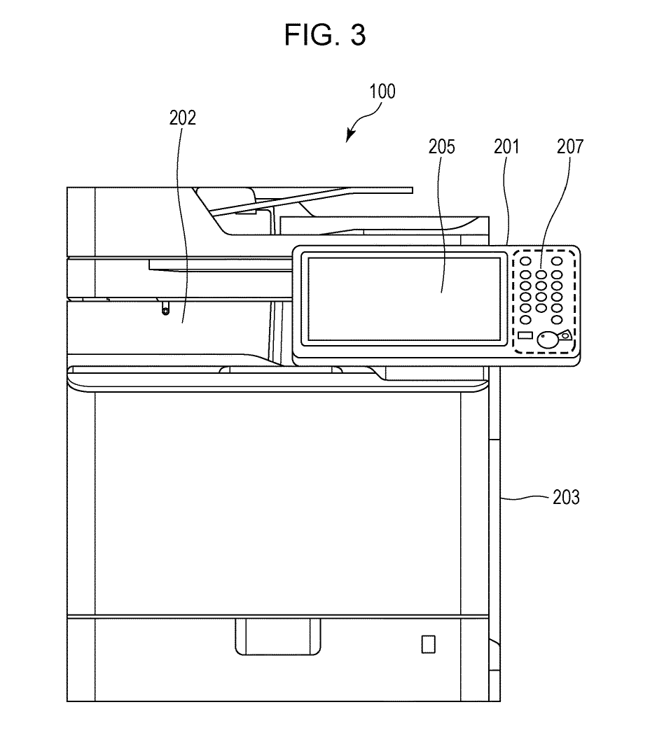

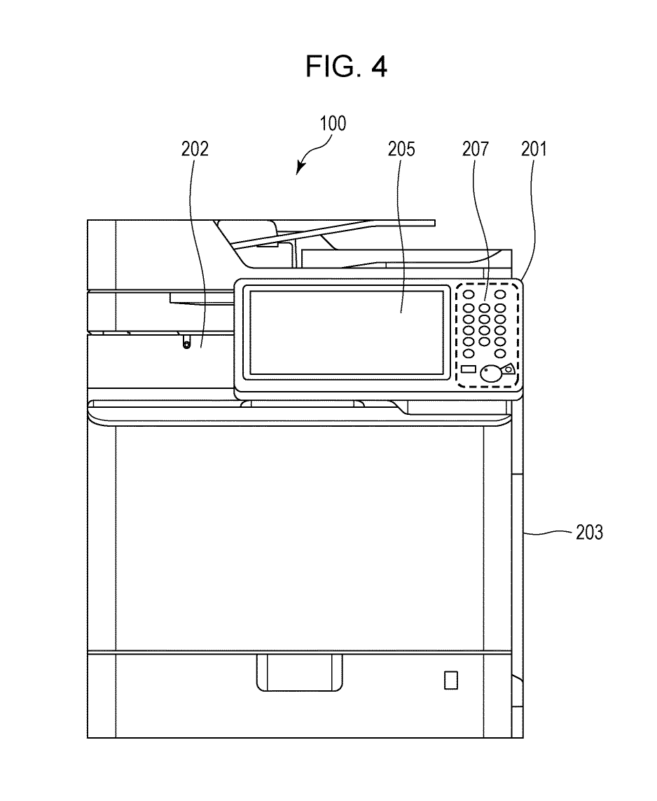

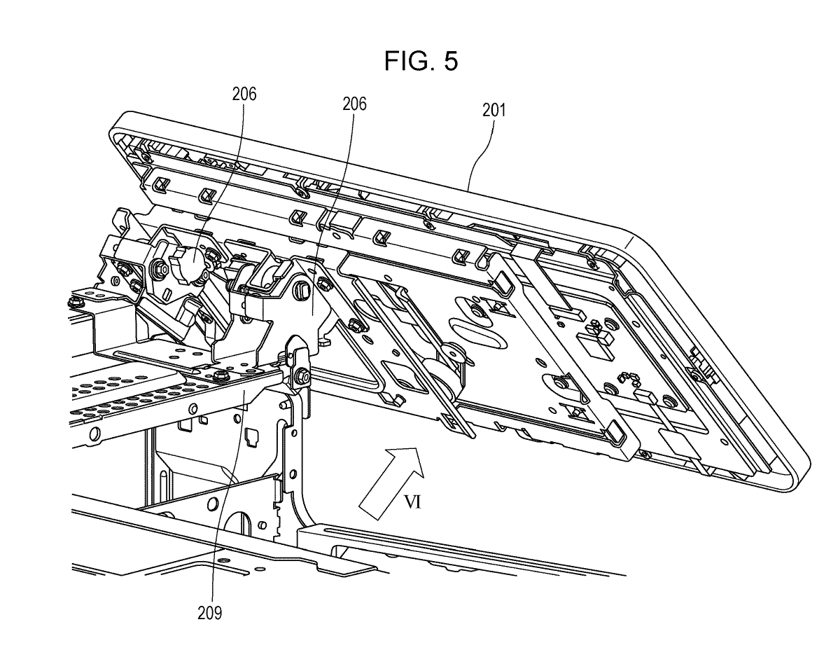

Referring to FIGS. 2 to 5, configurations of an operation unit 201 and an image forming apparatus 100 will be described. The configuration of the image forming apparatus 100 in which the operation unit 201 is equipped will be described first. In the image forming apparatus 100 in which the sheet on which an image has been formed is discharged to an in-body sheet discharge unit 202, as illustrated in FIG. 5, the operation unit 201 is fastened and fixed to a frame 209 of the image forming apparatus 100 with a screw through a hinge portion 206. Furthermore, the image forming apparatus 100 is provided with a cover 203 that can be opened and closed to remove a sheet in a case in which the sheet (a recording medium) on which an image has been formed stops in a conveyance path. By opening the cover 203, the operator can remove the sheet that has stopped in the conveyance path from the conveyance path. While the cover 203 disposed on the right side when viewing the image forming apparatus 100 from the front, the same function can be obtained with the cover 203 disposed on the left side. As illustrated in FIG. 3, the operation unit 201 of the present embodiment includes a large display unit 205 and a button portion 207 on the same plane. Note that in the present embodiment, the largest image forming size is the A4 size. In the above, the operation unit 201 is configured so as to be positioned at a position that does not cover the in-body sheet discharge unit 202, or at a position in which the amount in which the operation unit 201 covers the in-body sheet discharge unit 202 is small when priority is put on the visibility of the in-body sheet discharge unit 202. In such a case, the operation unit 201 protrudes with respect to the surface of the cover 203 equipped on the image forming apparatus 100. In other words, at least a portion of the operation unit 201 is, in the horizontal direction, positioned on the outer side of the main body of the apparatus with respect to the cover 203. Conversely, as illustrated in FIG. 4, the operation unit 201 is configured so as to be positioned inside the surface of the cover 203 of the image forming apparatus 100 when priority is put on the work efficiency of opening and closing the cover 203 equipped on the image forming apparatus 100. As described above, in the present embodiment, the operation unit 201 is supported in a slidable manner on the body side so that the operation unit 201 can be held at the positions illustrated in FIGS. 3 and 4 in order to both achieve visibility of the in-body sheet discharge unit 202 and the work efficiency of opening and closing the cover 203.

The positions of the operation unit 201 will be described next. As described above, the operation unit 201 can be positioned at two positions, namely, the position at which the operation unit 201 does not interfere access to the cover 203 during the sheet removing operation, and the position at which the visibility of the conveyed sheet discharged to the in-body discharge portion 202 is prioritized. As illustrated in FIG. 3, the position of the operation unit 201 protruding from the lateral side of the image forming apparatus 100 on which the cover 203 is provided is defined as a first position T1. Meanwhile, as illustrated in FIG. 4, the position of the operation unit 201 inside the first position T1 covering at least a portion of the in-body discharge portion 202 is defined as a second position 2.

Note that since the frequency in which the smallest-sized sheet is output is low, and since priority is put on the work efficiency of the sheet removing operation, desirably, in the operation unit 201, the second position T2 is set as the default position that is normally used.

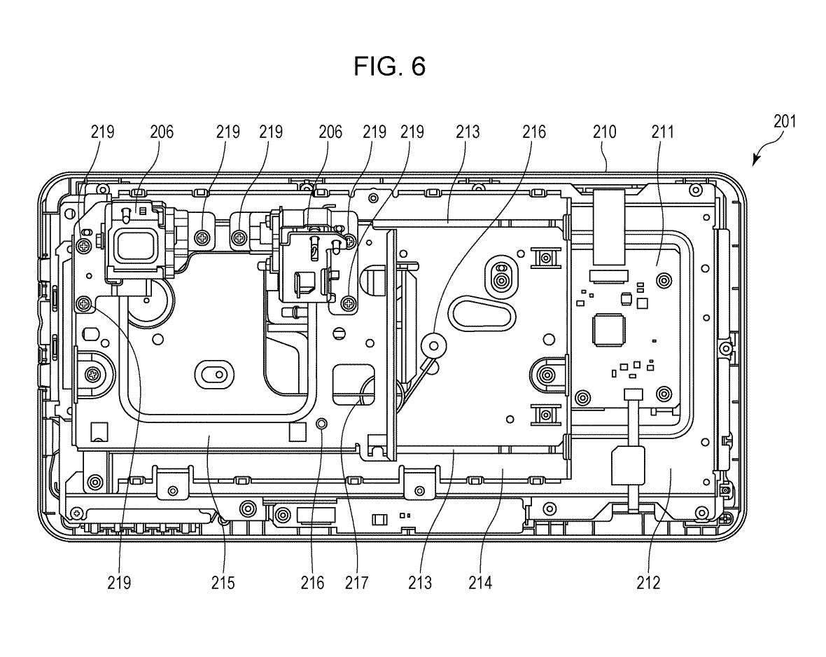

As described above, the position of the operation unit 201 is slid from the second position T2 to the first position T1 to increase the visibility of the in-body sheet discharge unit. Furthermore, in a case in which the conveyed sheet stopped inside the image forming apparatus 100 needs to be removed (during the jam clearance operation) when the operation unit 201 is at the first position T1, the operation unit 201 is slid from the first position T1 to the second position T2. As described above, in a case in which the operation unit 201 is configured in a slidable manner to increase the visibility of the discharged sheet inside the body, the trouble of moving the operation unit 201 when performing a jam clearance operation will increase, and a load will be imposed on the operator. Now, the ease of operation of sliding the operation unit 201 from the first position T1 to the second position 12 that is the default position is, desirably, increased to reduce the load on the operator during the jam clearance operation. Accordingly, in the present embodiment, as described later, a torsion spring 217 serving as an urging member that urges the operation unit 201 towards the destination of the movement is provided in the operation unit 201. Movement of the operation unit 201 towards the destination of movement is facilitated in the above manner (FIG. 6). In addition to the above, in the present embodiment, the operation load of sliding the operation unit 201 from the first position T1 to the second position 12, which is the default position, is set smaller than the operation load (physical force×slide distance) of sliding the operation unit 201 from the second position 12 to the first position T1. In other words, in the present embodiment, urging force of a spring is made to act in the sliding direction of the operation unit 201 by providing the torsion spring 217, and depending on the position of the operation unit 201, the direction of the urging force of the spring in the sliding direction is reversed. Furthermore, the position where the direction of the urging force is reversed is, between the first position T1 and the second position T2, set at a position that is closer to the first position T1. By so doing, the stroke amount needed when the operator moves the operation unit 201 during the jam clearance operation can be reduced and the load on the operator can be reduced. Furthermore, by adopting the configuration described above, an effect of having the user using the image forming apparatus recognize that the second position 12 is the default position of the operation unit 201 can be expected. Note that, in the present embodiment, the position where the direction of the spring urging force is reversed is provided at a position that is within at least 30% of the total stroke amount (distance) L0 from the first position T1. More preferably, the position where the direction of the spring urging force is reversed be provided at a position within 10% of the total stroke amount from the first position T1.

### Sliding Structure of Operation Unit 201

Referring to FIGS. 5 and 6, a sliding structure of the operation unit 201 will be described. FIG. 5 is a perspective view in which the operation unit 201 is fastened and fixed to the frame 209 of the image forming apparatus 100, and in which the cover that is a rear face of the operation unit 201 has been omitted. The main components of the operation unit viewed from the rear face includes an operation unit frame 210, the display unit 205, and an operation panel portion 212 on which a circuit board 211 is mounted. Furthermore, the operation unit 201 includes a rail unit 214 that includes rails 213 that constitute a mechanism that slides substantially parallel to a longitudinal direction of the operation panel portion 212. The operation unit 201 further includes a sliding member that makes a pair with the rail unit 214 and that slides on the rails 213, and a slide frame portion 215 that serves as a support unit and that supports the operation panel portion. 212 in a slidable manner. The operation panel portion 212 and the rail unit 214 are fastened with screws, and the hinge portion 206 is fastened to the slide frame portion 215 with screws, and the hinge portion 206 is fastened to the frame 209 with screws. Furthermore, the rail unit 214 and the slide frame portion 215 forming a pair with the sliding member in between are provided with the torsion spring 217 interposed between the rail unit 214 and the slide frame portion 215. Two end portions of arms of the torsion spring 217 are each processed to have a circular shape, and the circular inner circumferential surfaces thereof are fastened to the rail unit 214 and the slide frame portion 215 using stepped screws 216, so that the torsion spring 217 is pivotable about the center portion of the circular shape of each arm of the torsion spring 217.

### Sliding Function of Operation Unit 201

As described above, the rail unit 214 and the slide frame portion 215 are configured to be slidable through the sliding member. Accordingly, the operation panel portion 212 integral with the rail unit 214 can be slid with respect to the slide frame portion 215 that is fixed to the hinge portion 206 with screws and that is fixed to the frame 209 of the image forming apparatus 100 by moving the operation panel portion 212 substantially parallel to the rails 213. Moreover, the torsion spring 217 is fastened to each of the rail unit 214 and the slide frame portion 215 with the stepped screws 216. The torsion spring 217 is mounted to pull the operation panel portion 212 from the initial static position to the other static position when sliding the operation panel portion 212 so as to assist the operator in the physical force needed to slide the operation portion 212. Accordingly, owing to the action of the torsion spring 217, the static positions of the operation panel portion 212 are the positions where the slide frame portion 215 abut against two end portions of the rail unit 214. In other words, there are two static positions.

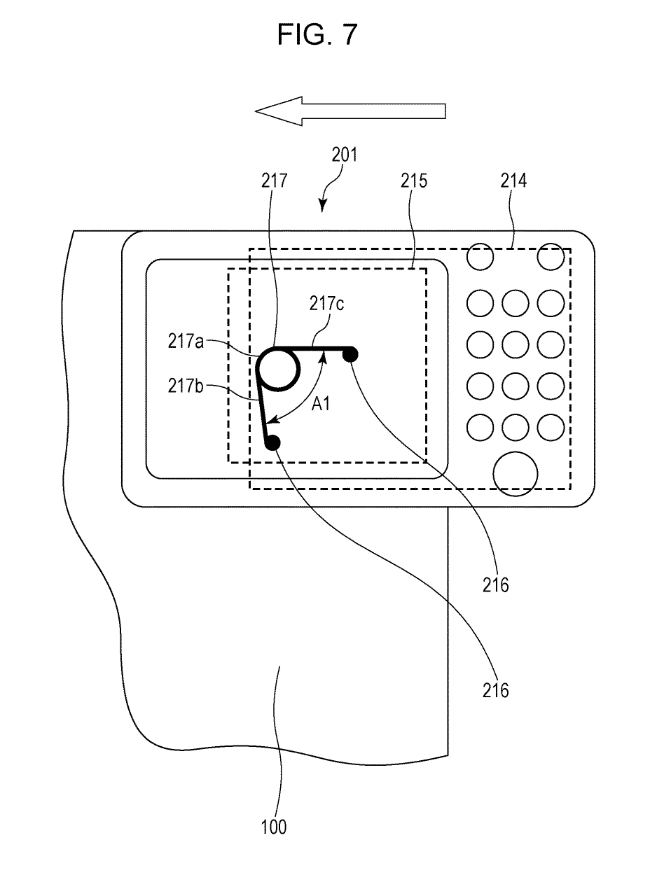

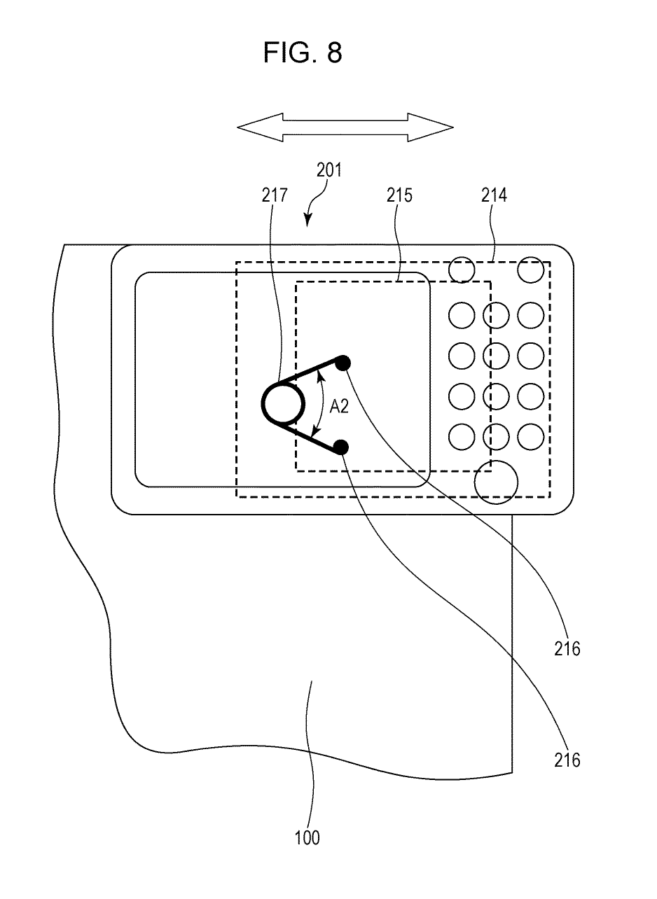

Referring next to FIGS. 7 to 9, a movement of the operation panel portion 212 sliding between the first position T1 and the second position T2 will be described. FIGS. 7 to 8 are schematic drawings for describing a movement of the operation panel portion 212 while viewing the image forming apparatus 100 from the front and are schematic diagrams in which the operation unit 201, the rail unit 214, the slide frame portion 215, the torsion spring 217, and the stepped screws 216 alone are selectively illustrated from the rear view of the operation unit in FIG. 6 described above.

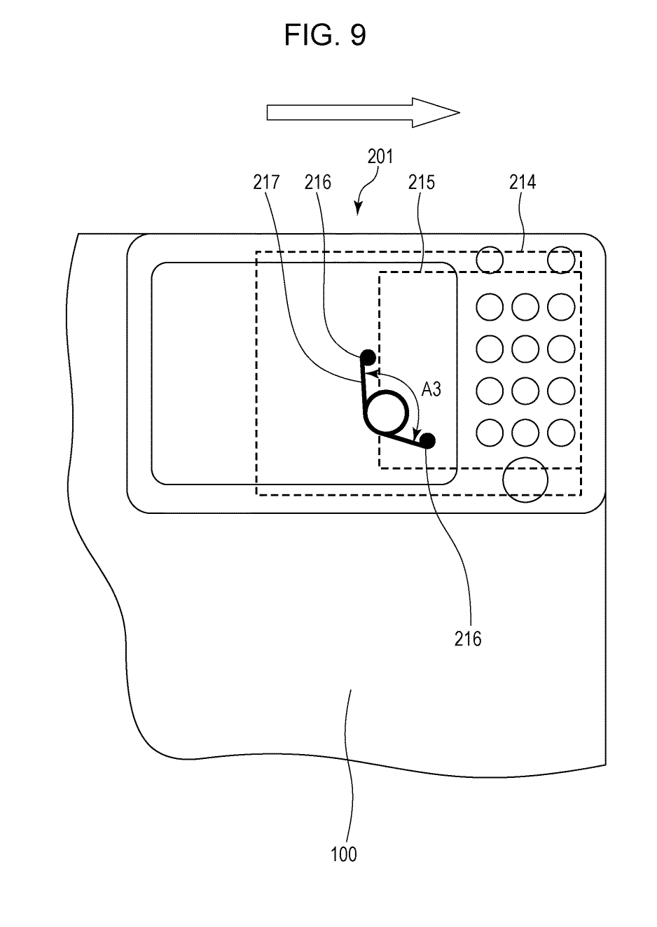

Referring first to FIG. 7, the first position T1 will be described. The first position T1 is a position of the operation unit 201 where the visibility of the in-body sheet discharge unit 202 is optimum, and is a position that is the same as the position in FIG. 3. In the above state, in a case in which the conveyed sheet becomes lammed due to a reason of some kind during formation of an image, the cover 203 needs to be opened and removal of the lammed sheet needs to be performed. In so doing, since the operation unit 201 protrudes from the image forming apparatus 100, the operator performs removal of the jammed sheet by sliding the operation unit 201 to the second position T2 illustrated in FIG. 4 or 9 first and opening the cover. The reason for performing the operation after sliding the operation unit 201 is because when the operator standing in front of the image forming apparatus 100 reaches a hand to a handle 204 (FIG. 2) of the cover 203, as illustrated in FIG. 2, the operation unit 201 becomes a block like a wall in front of the handle 204. Typically, the disposition of the handle 204 of the cover 203 is a position that is farthest from the rotating hinge of the cover 203 as much as possible so as to reduce the load on the user. The handle 204 is positioned above the image forming apparatus 100. Furthermore, the reason for the above is because in a case in which the operation unit is at the position illustrated in FIG. 3, the handle 204 is mostly positioned within a projection area of the operation unit 201 when viewed from substantially the front.

Referring next to FIG. 9, the second position 12 will be described. As described above, the second position T2 is a position of the operation unit 201 that is more appropriate than the first position T1 when the cover 203 opened and closed, and is a position that is the same as the position in FIG. 4. The second position T2 is a disposition that is inferior to the first position T1 regarding the visibility of the in-body sheet discharge unit 202. However, since the position of the operation unit 201 that has entered the visible area of the in-body sheet discharge unit 202 leaves an open space on the lateral side other than the front side, the sheet can be taken away without sliding the operation unit 201 by accessing the space inside the body through the space that is left open. Accordingly, even when the operation unit 201 is at the second position T2, the operation unit 201 does not necessarily have to always be slid to remove the discharged sheet. Accordingly, it is anticipated that the occasions of sliding the operation unit 201 from the second position T2 to the first position T1 is fewer than moving the operation unit 201 from the first position T1 to the second position T2. Accordingly, in the present embodiment, regarding the ease in operation of sliding the operation unit 201, the reduction in load on the operator when moving the operation unit 201 from the first position T1 to the second position T2 is considered sufficiently. In other words, assume that L1 is the stroke amount (distance) when moving the operation unit 201 from the first position T1 to the second position T2 while the operation unit 201 counters the urging force of the torsion spring 217. Furthermore, assume that L2 is the stroke amount when moving the operation unit 201 from the second position T2 to the first position T1 while the operation unit 201 counters the urging force of the torsion spring 217. The present embodiment is configured to satisfy L1<L2. Furthermore, assuming that L0 is the total stroke amount when moving the operation unit 201 from the first position T1 to the second position T2, the stroke amount L1 is set to 30% or less with respect to the total stroke amount L0. Furthermore, preferably, the stroke amount L1 is set to 10% or less with respect to the total stroke amount L0.

The adjustment of L1 and L2 can be easily made by adjusting the position where the torsion spring 217 is fitted and the relationship between the disposition of the rail unit 214 and the disposition of the slide frame portion 215. A specific description thereof will be described below.

In the present embodiment, as illustrated in FIG. 7, due to the dispositions of the rail unit 214 and the slide frame portion 215, the torsion spring 217 is held at arm angle A1 in the first position T1. Note that the arm angle is defined in the following manner. The torsion spring 217 serving as a spring member includes a spirally wound spring portion 217a, a first arm 217b serving as a first extension portion extended from a first end of the spring portion 217a, and a second arm 217c serving as torsion spring 217 extended from a second end of the spring portion 217a. The arm angle is an angle formed between the first arm 217b and the second arm 217c. Furthermore, as illustrated in FIG. 9, due to the dispositions of the rail unit 214 and the slide frame portion 215, the torsion spring 217 is held at arm angle A3 in the second position T2. The present embodiment satisfies the relationship A1<A3.

Referring next to FIG. 8, a position T3 (hereinafter, also referred to as a neutral position T3) that is a position between the first position T1 and the second position T2 and that is a position where the direction of the urging force of the torsion spring 217 acting in the sliding direction of the operation unit 201 is reversed will be described next. As illustrated in FIG. 8 the neutral position T3 in the present embodiment corresponds to a position in which the torsion spring 217 is attached at arm angle A2. The arm angle A2 of the torsion spring 217 corresponds to a position (a position having the largest spring force) in which the arm angle becomes the smallest during the sliding of the operation unit 201. In the present embodiment, the arm angles of the torsion spring 217 are set to a relationship satisfying A2<A1<A3. Furthermore, when the operation unit 201 is slid from the first position T1 to the second position T2, the arm angle changes from A1 to A2, and to A3. When the arm angle changes from A1 to A2, the torsion spring 217 is deformed in a direction in which the arm angle becomes smaller; accordingly, urging force moving back the operation unit 201 towards the first position acts on the operation unit 201. Subsequently, when the operation unit 201 moves through the neutral position T3, the arm angle changes from A2 towards A3, and the urging force acting on the operation unit 201 is reversed. Accordingly, when the operation unit 201 passes the neutral position T3, the operation unit 201 is urged towards the second position T2. In other words, with the neutral position T3 serving as a predetermined position and as a turning point, the torsion spring 217 is configured so as to be capable of urging the operation unit 201 towards the first position T1 or towards the second position T2.

On the other hand, when sliding the operation unit 201 from the second position 12 to the first position T1, the direction of the urging force of the spring changes at the neutral position T3 serving as the turning point in a similar manner to the above, and when the operation unit 201 passes the neutral position T3, the operation unit 201 is urged towards the first position.

As described above, the operation load (the force of the operator countering the torsion spring×slide distance) from the first position T1 to the second position T2 is set smaller that the operation load from the second position T2 to the first position T1. Note that in the present embodiment, the cover 203 and the operation unit 201 are disposed on the right side when viewing the image forming apparatus 100 from the front; however, even in a case in which the left and right are reversed and both members are disposed on the left side, a similar function can be obtained.

Note that it can be considered to be more effective when the operation load is set so that the operation unit 201 after start of the sliding reaches the neutral position T3 more quickly. The stroke amount L1 needed to move the operation unit 201 from the first position T1 to the second position 12 is proportionate to the angle difference when the mounting angle A1 is changed to the mounting angle A2. Accordingly, it is only sufficient to make the angle change amount (A1−A2) between the mounting angle A1 of the torsion spring 217 in FIG. 7 and the mounting angle A2 of the torsion spring 217 in FIG. 8 as small as possible. Furthermore, it is only sufficient to set the angle change amount (A1−A2) to be smaller than the angle change amount (A3−A2) between the mounting angle A2 of the torsion spring 217 in FIG. 8 and the mounting angle A3 of the torsion spring 217 in FIG. 9. In other words, it is only sufficient that the relationship mounting angle A1<mounting angle A3 is satisfied.

The mounting angle of the torsion spring 217 is set while taking the above relationship into account. By so doing, the stroke amount L1 from the first position T1 to the neutral position T3 can be smaller than the stroke amount L2 from the second position T2 to the neutral position T3 (L1<L2). Accordingly, the operation load when the operation unit 201 is slid is reduced and, as an effect, the load on the operator is reduced.

The present disclosure is, in an image forming apparatus in which an operation unit is slidable with respect to the body, capable of achieving both improvement in the visibility of a sheet discharge unit and avoiding a decrease in the ease of operating a jam clearance operation.

While the present invention has been described with reference to embodiments, it is to be understood that the invention is not limited to the disclosed embodiments. The scope of the following claims is to be accorded the broadest interpretation so as to encompass all such modifications and equivalent structures and functions.

This application claims the benefit of Japanese Patent Application No. 2016-191196 filed Sep. 29, 2016, which is hereby incorporated by reference herein in its entirety.

What is claimed is:

1. An image forming apparatus comprising:
a conveying unit configured to convey a recording medium;
a sheet discharge unit provided inside a body of the image forming apparatus and configured to receive the recording medium;
a cover provided on the image forming apparatus and configured to be opened and closed to allow access to the conveying unit;
an operation unit configured to be used to operate the image forming apparatus;
a support unit configured to support the operation unit in a slidable manner; and
an urging member configured to urge the operation unit towards a movement destination when the operation unit is slid,
wherein the operation unit is configured to slide to a first position protruding outside of the cover, and slide to a second position positioned inside the first position to cover at least a portion of the sheet discharge unit,
wherein the urging member is configured to urge the operation unit towards the first position when the operation unit is positioned nearer to the first position with respect to a predetermined position between the first position and the second position, and is configured to bias the operation unit towards the second position when the operation unit is positioned nearer to the second position with respect to the predetermined position, and
wherein L1<L2 is satisfied, where L1 is a stroke amount from the first position to the predetermined position, and L2 is a stroke amount from the second position to the predetermined position.

2. The image forming apparatus according to claim 1, wherein L1 is configured to be 30% or less with respect to L0, where L0 is a stroke amount from the first position to the second position.

3. The image forming apparatus according to claim 1, wherein L1 is configured to be 10% or less with respect to L0, where L0 is a stroke amount from the first position to the second position.

4. The image for apparatus according to claim 1,
wherein the urging member is a spring member having a first end attached to the operation unit and a second end attached to the support unit,
wherein the spring member includes a spirally wound spring portion, a first extension portion configured to extend from a first end of the spring portion, and a second extension portion configured to extend from a second end of the spring portion,
wherein a relationship A2<A1<A3 is satisfied, where A1 is an angle formed between the first extension portion and the second extension portion when the operation unit is positioned at the first position, A2 is an angle formed between the first extension portion and the second extension portion when the operation unit is positioned at the predetermined position, and A3 is an angle formed between the first extension portion and the second extension portion when the operation unit is positioned at the second position.

5. A method for an image forming apparatus having a conveying unit configured to convey a recording medium, a cover provided on the image forming apparatus and configured to be opened and closed to allow access to the conveying unit, and an operation unit configured to be used to operate the image forming apparatus, the method comprising:
conveying a recording medium by the conveying unit;
receiving the recording medium in a sheet discharge unit provided inside a body of the image forming apparatus;
supporting the operation unit in a slidable manner; and
urging the operation unit by an urging member towards a movement destination when the operation unit is slid,
wherein the operation unit is configured to slide to a first position protruding outside of the cover, and slide to a second position positioned inside the first position to cover at least a portion of the sheet discharge unit,
wherein the urging member is configured to urge the operation unit towards the first position when the operation unit is positioned nearer to the first position with respect to a predetermined position between the first position and the second position, and is configured to bias the operation unit towards the second position when the operation unit is positioned nearer to the second position with respect to the predetermined position, and
wherein L1<L2 is satisfied, where L1 is a stroke amount from the first position to the predetermined position, and L2 is a stroke amount from the second position to the predetermined position.
